(19) United States
(12) Patent Application Publication
(10) Pub. No.: US 2026/0249653 A1
(43) Pub. Date: Aug. 27, 2026

(54) HEAVY LOADING TIRE

(71) Applicant: Toyo Tire Corporation, Hyogo (JP)

(72) Inventor: Ayaki TANAKA, Hyogo (JP)

(21) Appl. No.: 19/546,664

(22) Filed: Feb. 23, 2026

(30) Foreign Application Priority Data
Feb. 25, 2025 (JP) 2025-028294

(51) Int. Cl. B60C 11/03; B60C 11/12

(52) U.S. Cl. CPC B60C 11/0309; B60C 11/1204; B60C 11/125; B60C 11/1259; B60C 2011/0353; B60C 2011/1213; B60C 2200/06

(57) ABSTRACT

A heavy loading tire includes a tread having a center land and shoulder lands. Prior to use, the center land and the shoulder lands have a block pattern formed by first circumferential grooves and a second circumferential groove extending in a tire circumferential direction, and first widthwise grooves and second widthwise grooves arranged in the tire circumferential direction. As the tread wears, a block pattern of the center land and the shoulder lands changes to a rib pattern.

### CROSS REFERENCE TO RELATED APPLICATION

This application claims priority to Japanese Patent Application No. 2025-028294 filed on Feb. 25, 2025, which is incorporated herein by reference in its entirety including the specification, claims, drawings, and abstract.

### TECHNICAL FIELD

The present disclosure relates to a heavy loading tire.

### BACKGROUND

A heavy loading tire for use in large size vehicles, for example, is subject to uneven tire wear because a center land having a high contact pressure is more likely to wear, while a significant transverse force is applied to a shoulder land when cornering. This is particularly notable when the heavy loading tire is mounted on an electric vehicle (EV) having a large body weight and applying a large torque to the tire. To achieve both wear resistance and wet performance, JP 2024-110220 A (Patent Document 1) discloses a tire having a configuration including a center land composed of center blocks and a center thin groove having a predetermined shape and disposed in the center block, with the center thin groove has two or more bent portions in the middle and has opposite ends communicating with center lug grooves, respectively, extending in the tire width direction.

### SUMMARY

Typically, increasing rigidity of the center land by decreasing the number of grooves and sipes or reducing the depth of the grooves and sipes increases wear resistance but lowers traction performance. The technology disclosed in Patent Document 1 is amenable to improvement regarding control of traction performance.

The present disclosure is aimed at providing a heavy loading tire providing superior effects of reducing uneven tire wear while also achieving both rigidity and traction performance of the center land.

A heavy loading tire according to the present disclosure includes a tread having a center land and shoulder lands. Prior to use, the tread of the heavy loading tire includes a first circumferential groove extending in a tire circumferential direction between the center land and each of the shoulder lands, and the center land includes, in a substantially center of the center land in the tire width direction, a second circumferential groove extending in the tire circumferential direction. The center land is segmented into center blocks by the second circumferential groove and first widthwise grooves arranged in the tire circumferential direction. The shoulder lands are each segmented into shoulder blocks by second widthwise grooves arranged in the tire circumferential direction. The first widthwise grooves and the second widthwise grooves have a depth equal to 10% to 30% of a depth of the first circumferential grooves. The first widthwise grooves each include, on a groove bottom, a first groove bottom sipe, and the second widthwise grooves each include, on a groove bottom, a second groove bottom sipe. The center blocks include a curved sipe and a short sipe. The curved sipe extends in the tire circumferential direction and has open ends opened to the first widthwise grooves, respectively, and the curved sipe bends in two places. The short sipe extends in the tire circumferential direction, and the short sipe has an open end opened to the first widthwise grooves and a second end closed within the center block. With wear of the tread, the first widthwise grooves and the second widthwise grooves disappear, and patterns of the center land and the shoulder lands change from a block pattern to a rib pattern.

In the above heavy loading tire, the second circumferential groove may prior to use have a width that is smaller than a width of the first circumferential grooves, and the width of the first circumferential grooves may decrease due to wear of the tread.

In the above heavy loading tire, the curved sipe may maintain their initial unused shape when the first widthwise grooves and the second widthwise grooves disappear, and then, with further wear of the tread, the curved sipe may be segmented into three parts with the bending portions having disappeared.

In the above heavy loading tire, the first groove bottom sipes and the second groove bottom sipes may maintain their shapes prior to use as the first widthwise grooves and the second widthwise grooves disappear, and, with further wear of the tread, the first groove bottom sipes and the second groove bottom sipes may be each segmented into two parts with a center portion having disappeared.

In the above heavy loading tire, the first groove bottom sipes may remain when the second groove bottom sipes disappear as there is further wear of the tread.

The heavy loading tire according to the present disclosure provides superior effects of reducing uneven tire wear while achieving both rigidity and traction performance of the center land.

### BRIEF DESCRIPTION OF DRAWINGS

An embodiment of the present disclosure will be described based on the following figures, wherein:

FIG. 1 is a perspective view partially illustrating a heavy loading tire according to an example embodiment;

FIG. 2 is an enlarged view partially illustrating a tread in the heavy loading tire according to the example embodiment;

FIG. 3 is a cross sectional view taken along A-A line in FIG. 2;

FIG. 4 is a cross sectional view taken along B-B line in FIG. 2;

FIG. 5 is a cross sectional view taken along C-C line in FIG. 2;

FIG. 6 is a cross sectional view taken along D-D line in FIG. 2;

FIG. 7 is an enlarged view of a center block in the heavy loading tire according to the example embodiment;

FIG. 8 is a cross sectional view taken along E-E line in FIG. 7;

FIG. 9 shows change due to wear of a tread of the heavy loading tire according to the example embodiment; and

FIG. 10 is an enlarged view partially illustrating a sidewall of the heavy loading tire according to the example embodiment.

### DESCRIPTION OF EMBODIMENTS

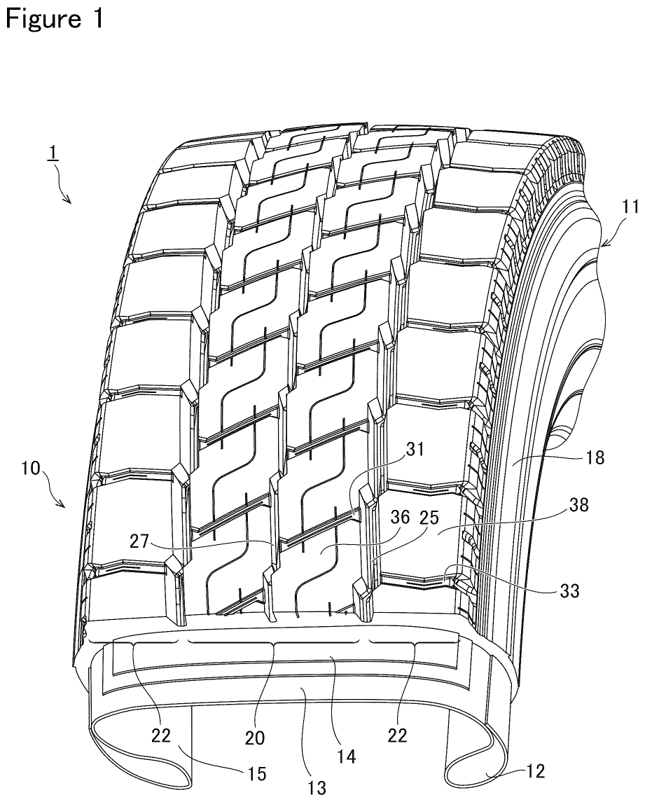

A heavy loading tire according to an example embodiment of the present disclosure will be described with reference to the drawings. The embodiment described below is only one example, and the present disclosure is not limited to the following embodiment. Further, selective combinations of elements in a plurality of embodiments and modification examples described below are included in the present disclosure. FIGS. 1 to 8 all illustrate an embodiment of the tread 10 of the heavy loading tire prior to use. In the following description, the term “depth” refers to the maximum depth.

FIG. 1 is a perspective view partially illustrating a heavy loading tire 1 according to an example embodiment, and also illustrating the inner configuration of the tire. As illustrated in FIG. 1, the heavy loading tire 1 includes a tread 10 that comes into contact with the road surface, a pair of sidewalls 11 extending inward in the tire radial direction from the tread 10, and a pair of beads 12 contacting rims of respective wheels. The tread 10, the sidewalls 11, and the beads 12 are formed annularly along the tire circumferential direction. The sidewalls 11 and the beads 12 constitute the left and right side faces of the heavy loading tire 1.

The heavy loading tire 1 further includes a carcass 13, a belt 14, and an inner liner rubber 15. The carcass 13 is a rubber-coated ply of cord layers constituting a frame of the heavy loading tire 1 that resists load, impact, and air pressure, for example. The carcass 13 runs between the beads 12 radially inside the tread 10, and is folded over at respective beads 12 from radially inside to radially outside. The belt 14 is a reinforcing band disposed radially outward of the carcass 13 to tighten the carcass 13 hard to thereby increase rigidity of the heavy loading tire 1. The belt 14 is composed of rubber-coated steel cords, for example. The inner liner rubber 15 is a rubber layer disposed radially inward of the carcass 13 to maintain air pressure of the heavy loading tire 1.

The heavy loading tire 1 further includes bead cores and bead fillers. A bead core and a bead filler are disposed within the bead 12 on both sides of the tire. The bead core is an annular member of a bundle of steel wires coated with rubber. The bead filler is composed of hard rubber and functions to increase rigidity of the bead 12.

The sidewall 11 includes a side protector 18 protruding outward of the tire beyond the profile face. The “profile face” as used herein refers to a profile of an outer surface of the sidewall body excluding protrusions such as the side protector 18. The side protector 18 is formed annularly along the tire circumferential direction. The side protector 18 increases the thickness of the sidewall 11 to thereby enhance damage resistance.

In some embodiments, the side protector 18 may have a flat top face. The flat top face of the side protector 18 improves air flow in the vicinity of the tire and reduces air resistance. While the top face of a side protector typically includes protruding side ribs having combinations of straight lines and curved lines or depressions having a concave shape, a top face of the side protector 18 which is flat and has no patterning or lettering achieves the above advantage.

The tread 10 includes a center land 20 and shoulder lands 22. A first circumferential groove 25 extending in the tire circumferential direction is disposed between the center land 20 and each shoulder land 22. A second circumferential groove 27 extending in the tire circumferential direction is disposed at the substantial center of the center land 20 in the tire width direction. The center land 20 is divided in the tire width direction into a left part and a right part by the second circumferential groove 27. The center land 20 is divided by a plane that passes the second circumferential groove 27 and is normal to the tread 10 into the left part and the right part having mutually identical shapes. In the example illustrated in FIG. 1, the second circumferential groove 27 and the two first circumferential grooves 25 have substantially the same depth. Here, the depth of the first circumferential groove 25 and the depth of the second circumferential grooves 27 refer to a distance from the upper face of the tread 10 to the groove bottom face in the tire radial direction. The depths of the first circumferential groove 25 and the second circumferential grooves 27 may be substantially uniform along the entire circumference of the tire.

In the example illustrated in FIG. 1, the center land 20 is segmented into center blocks 36 by the second circumferential grooves 27 and first widthwise grooves 31 arranged in the tire circumferential direction. Further, each shoulder land 22 is segmented into shoulder blocks 38 by second widthwise grooves 33 arranged along the tire circumferential direction.

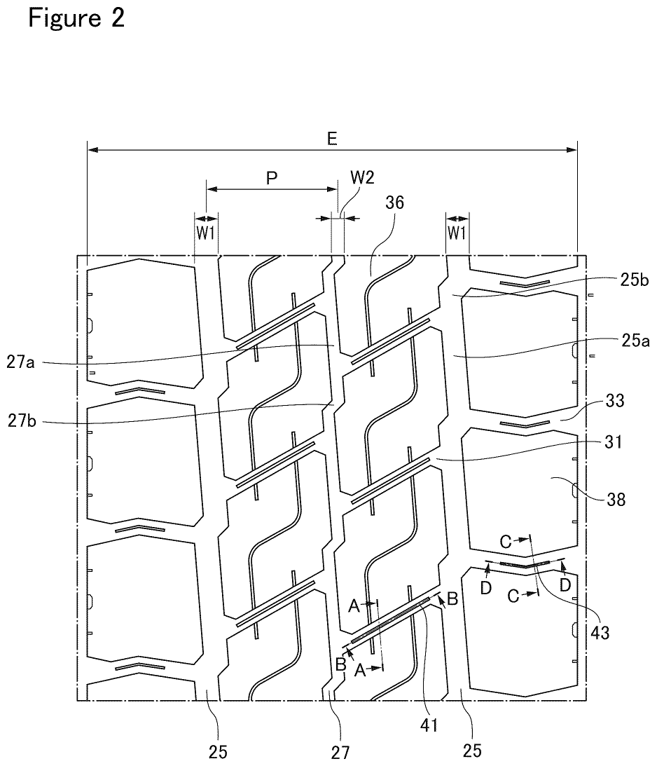

The tread 10, and particularly the center land 20, will be described in more detail with reference to FIGS. 2 to 9. FIG. 2 is an enlarged view partially illustrating the tread 10 in the heavy loading tire 1 according to this example embodiment.

Preferably, the width W1 of the first circumferential groove 25 is 2.5% to 7% of the width E between the contact ends of the tread 10, the width W2 of the second circumferential groove 27 is 2% to 5% of the width between the contact ends of the tread 10, and the distance P between the first circumferential groove 25 and the second circumferential groove 27 is 20% to 28% of the width E between the contact ends of the tread 10. This configuration increases the size of the center blocks 36 to enhance rigidity, thereby reducing excessive movement of the center blocks 36 when contacting the ground. The number of pitches of the center blocks 36 and the shoulder blocks 38 in the tire circumferential direction is not particularly limited, and may be, for example, 50 or less. Reducing the number of pitches enables further increasing the sizes of the center blocks 36 and the shoulder blocks 38.

In the present specification, contact ends refer to opposite ends in the tire axial direction of a region of an unused heavy loading tire 1 contacting a flat road surface when the heavy loading tire 1 is mounted on a normal rim and inflated to a normal internal pressure. A load corresponding to 88% of the normal load (maximum load capacity) under the normal internal pressure is applied to the heavy loading tire 1.

A “normal rim” as used herein refers to a rim defined according to a tire standard, such as a “standard rim” according to the Japanese Automobile Tire Manufacturing Association (JATMA), a “Design Rim” according to the Tire and Rim Association (TRA), or a “Measuring Rim” according to the European Tire and Rim Technical Organization (ETRTO). The “normal internal pressure” may be a “maximum air pressure” according to JATMA, the maximum value in a TRA table “TIRE LOAD LIMITS AT VARIOUS COLD INFLATION PRESSURES”, or an “INFLATION PRESSURE” according to ETRTO. A “normal load” is a “maximum load rating” according to JATMA, the maximum value listed in a TRA Table “TIRE LOAD LIMITS AT VARIOUS COLD INFLATION PRESSURES”, or a “LOAD CAPACITY” according to ETRTO.

The width W2 of the second circumferential groove 27 is preferably smaller than the width W1 of the first circumferential groove 25. This configuration increases the size of the center blocks 36 and enhances rigidity, thereby reducing excessive movement of the center blocks 36 when contacting the ground.

The first circumferential groove 25 may extend in a zigzag manner in the tire circumferential direction, and the second circumferential groove 27 may similarly extend in a zigzag manner in the tire circumferential direction. In the example illustrated in FIG. 2, the first circumferential groove 25 is configured by alternately coupling first inclination portions 25 a inclined by 3° to 10° with respect to the tire circumferential direction and second inclination portions 25 b inclined by 30° to 60° with respect to the tire circumferential direction. The first inclination portion 25a is longer than the second inclination portion 25b. The second circumferential groove 27 is configured by alternately coupling third inclination portion 27 a inclined by 3° to 10° with respect to the tire circumferential direction and fourth inclination portions 27 b inclined by 30° to 60° with respect to the tire circumferential direction. The third inclination portion 27a is longer than the fourth inclination portion 27b.

The first widthwise groove 31 is inclined at a predetermined angle with respect to the tire width direction. The angle of the first widthwise groove 31 with respect to the tire equator or tire center line is between 55° and 85°, for example. The first widthwise groove 31 has, on its bottom face, a first groove bottom sipe 41 that is substantially parallel to the first widthwise groove 31. This configuration secures rigidity of the center block 36 while simultaneously securing a desired traction performance. The first groove bottom sipe 41 allows the center blocks 36 adjacent to each other in the tire circumferential direction to substantially contact with each other on the contact patch; therefore, the center land 20 having a block pattern ensures high rigidity that is substantially equivalent to that of the center land having a rib pattern. Sipe as used herein refers to a thin linear groove having a smaller width than the circumferential grooves and the widthwise grooves. In the present specification, a groove having a groove width that is less than 1.5 mm is considered a sipe.

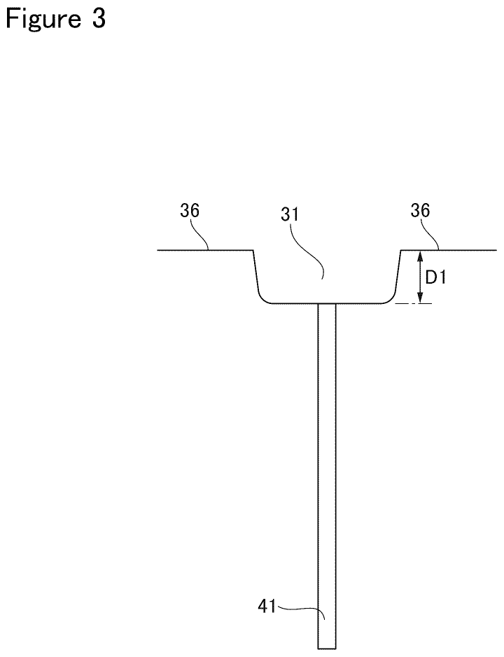

FIG. 3 illustrates a cross section taken along line A-A in FIG. 2, which shows cross sections of the first widthwise groove 31 and the first groove bottom sipe 41. The first widthwise groove 31 and the first groove bottom sipe 41 may have a substantially rectangular cross section. The first groove bottom sipe 41 is formed at substantially the center of the bottom face of the first widthwise groove 31 in the width direction.

The depth D1 of the first widthwise groove 31 is 10% to 30% of the depth of the first circumferential groove 25. A depth D1 that is less than 10% of the depth of the first circumferential groove 25 lowers traction performance, while a depth D1 that is over 30% of the depth of the first circumferential groove 25 lowers rigidity of the center blocks 36. Here, the depth D1 of the first widthwise groove 31 refers to a distance from the upper face of the center block 36 to the groove bottom face in the tire radial direction. The depth of the first widthwise groove 31 is substantially uniform from an end communicating with the first circumferential groove 25 to an end communicating with the second circumferential groove 27.

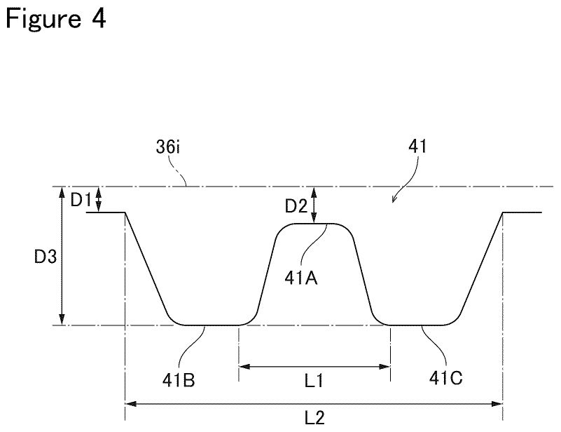

FIG. 4 illustrates a cross section taken along line B-B of FIG. 2, which shows an embodiment of the bottom face of the first groove bottom sipe 41. To illustrate the depth of the first groove bottom sipe 41, FIG. 4 shows a virtual line 36i indicating the top face of the center block 36. The center portion 41A of the first groove bottom sipe 41 has a smaller depth than the depth of an inward portion 41B adjacent to the center portion 41A on the inward side in the tire width direction and the depth of an outward portion 41C adjacent to the center portion 41A on the outward side in the tire width direction. The depth D2 of the center portion 41A is, for example, 20% to 40% of the depth of the first circumferential groove 25, while the depths D3 of the inward portion 41B and the outward portion 41C are, for example, 80% to 100% of the depth of the first circumferential groove 25. This configuration provides notable effects of achieving both rigidity and traction performance of the center blocks 36. As illustrated in FIG. 4, the center portion 41A may have a flat bottom face having a depth of D2, and the inward portion 41B and the outward portion 41C may each have a flat bottom face having a depth of D3. The length L1 of the center portion 41A is, for example, 25% to 75% of the entire length L2 of the first groove bottom sipe 41. A region inward of the inward portion 41B in the tire width direction and a region outward of the outward portion 41C in the tire width direction communicate with the first widthwise groove 31 having a depth D1.

As illustrated in FIG. 2, the second widthwise groove 33 may include bends. The second widthwise groove 33 may include, on its groove bottom, a second groove bottom sipe 43 that is substantially parallel to the second widthwise groove 33. This configuration enables the shoulder blocks 38 to simultaneously secure both rigidity and traction performance. The second groove bottom sipe 43 is formed substantially parallel to the second widthwise groove 33 and may be bent similar to the second widthwise groove 33. Further, as described below, the bent portions may have a smaller depth than other portions. The second groove bottom sipe 43 enables the shoulder blocks 38 adjacent to each other in the tire circumferential direction to substantially contact with each other on the contact patch, allowing the shoulder land 22 having a block pattern to have high rigidity, equivalent to that of the shoulder land 22 having a rib pattern.

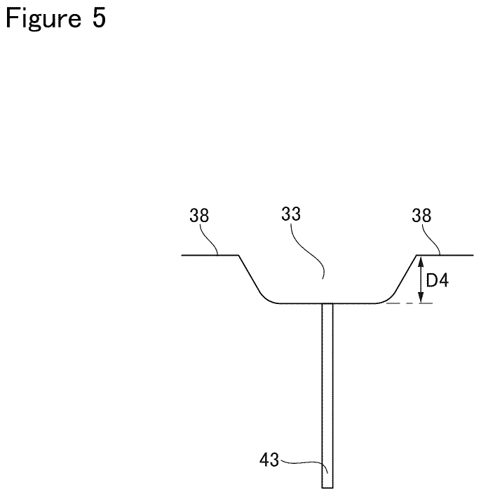

FIG. 5 illustrates a cross section taken along C-C line of FIG. 2, showing cross sections of the second widthwise groove 33 and the second groove bottom sipe 43. The second widthwise groove 33 and the second groove bottom sipe 43 may have a substantially rectangular cross section. The second groove bottom sipe 43 is formed at substantially the center of the bottom face of the second widthwise groove 33 in the width direction.

The depth D4 of the second widthwise groove 33 is 10% to 30% of the depth of the first circumferential groove 25. The depth D4 of the second widthwise groove 33 that is less than 10% of the depth of the first circumferential groove 25 lowers traction performance, and the depth D4 that is over 30% of the depth of the first circumferential groove 25 lowers rigidity of the shoulder block 38. The depth D4 of the second widthwise groove 33 refers to a distance from the top face of the shoulder block 38 to the groove bottom face in the tire radial direction. The depth of the second widthwise groove 33 is substantially uniform from an end communicating with the first circumferential groove 25 to the contact end.

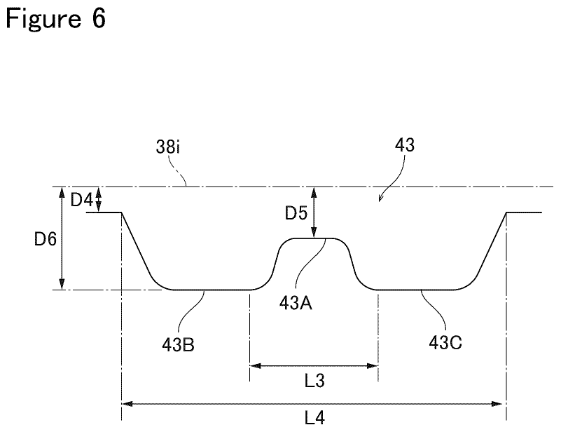

FIG. 6 illustrates a cross section taken along D-D line of FIG. 2, which shows an embodiment of the bottom face of the second groove bottom sipe 43. To illustrate the depth of the second groove bottom sipe 43, FIG. 6 shows a virtual line 38i indicating the top face of the shoulder block 38. A center portion 43A of the second groove bottom sipe 43 has a smaller depth than the depth of an inward portion 43B adjacent to the center portion 43A on the inward side in the tire width direction and the depth of an outward portion 43C adjacent to the center portion 43A on the outward side in the tire width direction. The depth D5 of the center portion 43A is, for example, 20% to 40% of the depth of the first circumferential groove 25, and the depths D6 of the inward portion 43B and the outward portion 43C are, for example, 50% to 70% of the depth of the first circumferential groove 25. This configuration provides notable effects of achieving both rigidity and traction performance of the shoulder blocks 38. As illustrated in FIG. 6, the center portion 43A may have a flat bottom face having a depth of D5, and the inward portion 43B and the outward portion 43C may have a flat bottom face having a depth of D6. The length L3 of the center portion 43A is, for example, 25% to 75% of the entire length L4 of the second groove bottom sipe 43. A region inward of the inward portion 43B in the tire width direction and a region outward of the outward portion 43C in the tire width direction communicate with the second widthwise groove 33 having a depth D4.

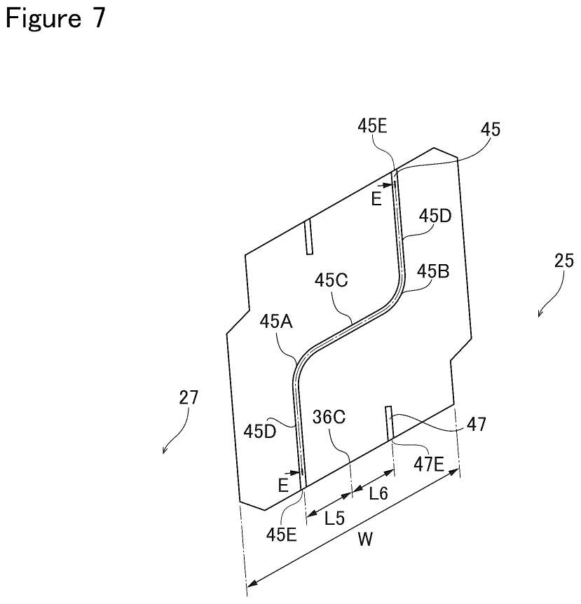

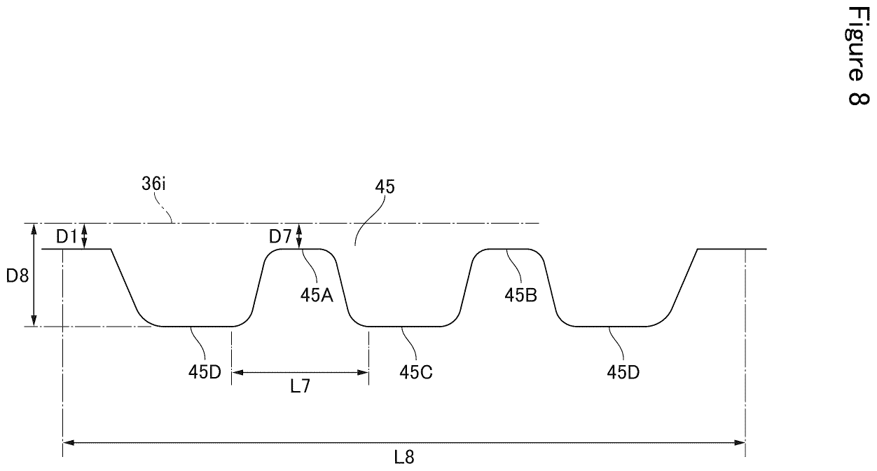

The center block 36 will now be described in detail with reference to FIGS. 7 and 8. FIG. 7 is an enlarged view of the center block 36 in the heavy loading tire 1 according to the example embodiment. In FIG. 7, the first circumferential groove 25 is disposed on the right side of the center block 36, and the second circumferential groove 27 is disposed on the left side of the center block 36. The center block 36 has a substantially parallelogram shape, with a pair of vertexes being significantly chipped. This configuration enables prevention of uneven tire wear at the acute angle portions of the center block 36. The portions of the center block 36 where the vertexes are chipped may have a size of 7% to 15% of the center block width and 7% to 15% of the center block circumferential width.

The center block 36 includes a curved sipe 45 and a short sipe 47. The curved sipe 45 extends in the tire circumferential direction with its ends being open to the first widthwise groove 31, and has bending portions 45A and 45B at two locations. The curved sipe 45 further includes a first linear portion 45C between bent portions 45A and 45B, and second linear portions 45D between each of the bent portions 45A and 45B and respective open ends 45E. The second linear portion 45D extends in a direction substantially parallel to the widthwise edges of the center block 36, that is, parallel to at least one of the first circumferential groove 25 and the second circumferential groove 27. The first linear portion 45C extends substantially parallel to the first widthwise groove 31 and extends in the vicinity of the center of the center block 36 in the circumferential direction. The first linear portion 45C and the second linear portion 45D intersect each other at an obtuse angle creating a bending portion at a point of intersection. The short sipe 47 extends in the tire circumferential direction, with a first end being open to the first widthwise groove 31 and a second end being closed within the center block 36. Including the curved sipe 45 within the center block 36 allows the curved sipe 45 to separate the center block 36 in the tire width direction into two regions which engage with each other to reduce the movement of the center block 36. This reduces sliding of the center block 36 at the time of rolling and turning and thereby reduces uneven tire wear. Inclusion of the short sipe 47 within the center block 36 further reduces movement of the center block 36 toward the tire width direction to thereby further reduce uneven tire wear. The length of the short sipe 47 is 5% to 15% with respect to the circumferential length of the center block 36. In consideration of balance adjustment of rigidity within the center block 36, the bending portions 45A and 45B are preferably located at substantially the center in the tire circumferential length of the center block 36.

In the example illustrated in FIG. 7, the distance L5 between the open end 45E and the center 36C and the distance L6 between the open end 47E and the center 36C are both 15% to 20% of the width W of the center block 36. In other words, the open end 45E of the curved sipe 45 and the open end 47E of the short sipe 47 are located within the range of 15% to 20% of the width of the center block 36 from the center 36C of the center block 36 in the tire width direction, for example. This configuration further improves the balance of rigidity of the center block 36.

FIG. 8 illustrates a cross section taken along line E-E of FIG. 7, and shows an embodiment of the bottom face of the curved sipe 45. To illustrate the depth of the bending sipe 45, FIG. 8 shows a virtual line 36i indicating the top face of the center block 36. The bending portions 45A and 45B of the curved sipe 45 have a smaller depth than those of the first linear portion 45C and the second linear portion 45D. The depth D7 of the bending portions 45A and 45B is, for example, 5% to 30% of the depth of the first circumferential groove 25, and the depth D8 of the first linear portion 45C and the second linear portion 45D is, for example, 50% to 70% of the depth of the first circumferential groove 25. This configuration provides notable effects of achieving both rigidity and traction performance of the center block 36. As illustrated in FIG. 8, the bending portions 45A and 45B may have a flat bottom face having a depth of D7, and the first linear portion 45C and the second linear portion 45D may have a flat bottom face having a depth of D8. The length L7 of the bending portions 45A and 45B is, for example, 10% to 30% of the entire length L8 of the curved sipe 45. The end portions of the second linear portions 45D communicate with the first widthwise groove 31 having a depth D1.

The depth of the short sipe 47 is not specifically limited, and may be 10% to 30% of the depth of the first circumferential groove 25, for example. This configuration provides notable effects of achieving both rigidity and traction performance of the center block 36. The short sipe 47 may have a flat bottom face with a uniform depth.

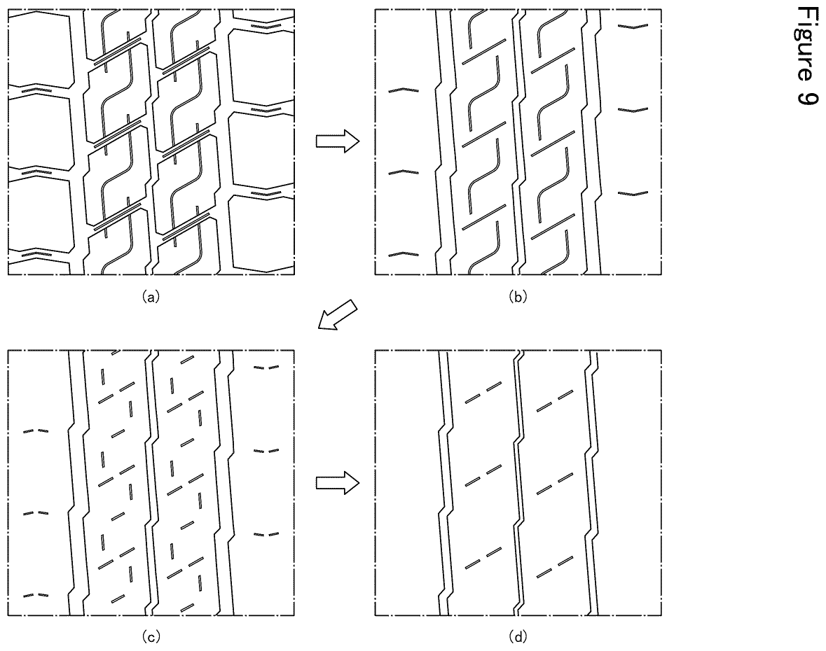

In the above, a heavy loading tire in a state prior to use has been described with reference to FIGS. 1 to 8. Next, change in the tread 10 due to wear will be described with reference to FIG. 9.

FIG. 9 shows change caused by wear of the tread 10 of the heavy loading tire 1 according to the example embodiment. As illustrated in FIG. 9, in the prior-to-use state of the heavy loading tire 1 illustrated in FIG. 9(a), the center land has a block pattern segmented by the widthwise grooves.

As the tire is used, the tread wears out, and in the state illustrated in FIG. 9(b), the first widthwise grooves and the second widthwise grooves have disappeared, and the patterns of the center land and the shoulder lands have changed from a block pattern to a rib pattern. Further, in the center land, the short sipes have also disappeared. Still further use of the tire changes the tread into the shape illustrated in FIG. 9(c). While the widthwise grooves are disposed to achieve excellent traction performance in the state of the tire prior to use, with the change of a contact state between the tire top face and the ground face caused by the use of the tire, the widthwise grooves disappear, but sufficient traction performance can still be achieved by the sipes.

As illustrated in FIG. 9(b), the curved sipes remain in the same shape as prior to use of the tire even as the first widthwise grooves disappear. With further wear of the tread, the curved sipes may form three divided parts after the curved portions have disappeared, as illustrated in FIG. 9(c).

As illustrated in FIG. 9(b), when the first widthwise grooves and the second widthwise grooves disappear, the first groove bottom sipes and the second groove bottom sipes remain in the same shapes as prior to use of the tire With further wear of the tread, the groove bottom sipes may be divided into two parts with the center portion having disappeared, as illustrated in FIG. 9(c).

As illustrated in FIG. 9(d), the first groove bottom sipes may remain after the second groove bottom sipes have disappeared due to the further wear of the tread. The center land has a higher contact pressure than the side lands; therefore, allowing the sipes to remain in the center land even after the sipes disappear in the side lands enables securing traction performance of the tire. With further progress of wear, the tread eventually assumes a state where all the sipes have disappeared. In this state, a tread wear indicator appears on the tire top face, indicating that the tire should be replaced.

Prior to use, the width of the second circumferential groove is smaller than the width of the first circumferential groove. Therefore, the width of the first circumferential groove may be reduced due to wear. The inclination of the side face of the first circumferential groove in the tire radial direction, which is greater than the inclination of the side face of the second circumferential groove in the tire radial direction, enables the tread to change as described above. The increased inclination of the side face of the first circumferential groove having a greater width than that of the second circumferential groove as described above prevents catching of foreign matter such as stones in the first circumferential groove.

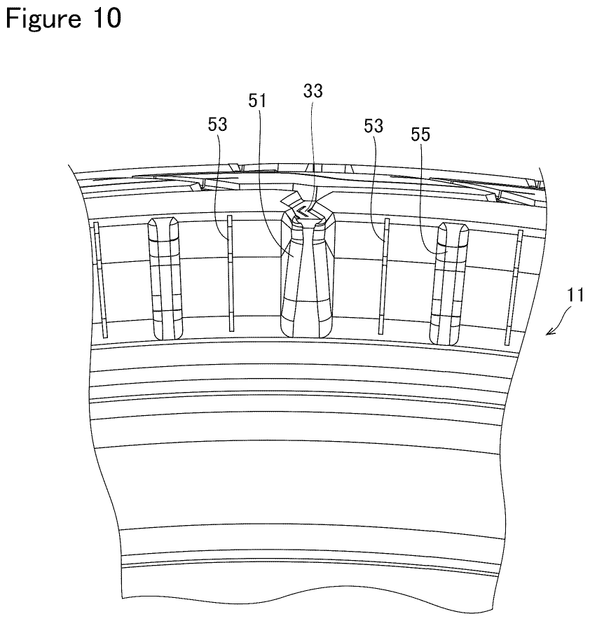

A region in the sidewall 11, particularly a region in the vicinity of a buttress portion will now be described with reference to FIG. 10. FIG. 10 is an enlarged view illustrating a part of the sidewall 11 of the heavy loading tire 1 according to the example embodiment.

The second widthwise groove 33 communicates with a lug groove 51 formed on the sidewall 11, and the lug groove 51 may have a greater depth than that of the first circumferential groove in the tire radial direction. In large size vehicles such as buses and trucks, for example, the treads are invisible and cannot be visually recognized, and therefore the sidewalls 11 are typically used to confirm wear of the tires. Increase in the depth of the lug groove 51 in the tire radial direction enables accurate recognition of the extent of wear of the tire.

A side sipe 53 may be disposed between the lug grooves 51. Further, a recessed window 55 having a greater width than the side sipe 53 may also be provided. The side sipe 53 or the recessed window 55 provides flexibility to the shoulder land 22 near its contact end, thereby enhancing traveling stability on uneven road surfaces. In the example illustrated in FIG. 10, between one lug groove 51 and an adjacent lug groove 51, two side sipes 53 and one recessed window 55 are disposed, sequentially in the order of the side sipe 53, the recessed window 55, and the side sipe 53.

A first end of the side sipe 53 may in the tire radial direction be in contact with the contact end, or extend to the tread 10 across the contact end. A second end of the side sipe 53 may extend to a location that is deeper than the first circumferential groove. This configuration mitigates transverse force applied to the shoulder land 22 to thereby reduce uneven tire wear. In the example illustrated in FIG. 10, the first end of the side sipe 53 extends to the tread 10 across the contact end.

As described above, the heavy loading tire according to the present disclosure simultaneously establishes superior rigidity and traction performance of the center land, while also providing an advantageous effect of reducing uneven tire wear. Specifically, the tread prior to use includes a center land and a shoulder land having a predetermined shape, and as the tread wears the pattern of the center land and shoulder land changes from the block pattern to the rib pattern, to thereby achieve the above effect.

### REFERENCE SIGNS LIST

1 heavy loading tire, 10 tread, 11 sidewall, 12 bead, 12a bead core, 12b bead filler, 13 carcass, 14 belt, 15 inner liner rubber, 20 center land, 22 shoulder land, 25 first circumferential groove, 27 second circumferential groove, 31 first widthwise groove, 33 second widthwise groove, 36 center block, 38 shoulder block, 41 first groove bottom sipe, 43 second groove bottom sipe, 45 curved sipe, 47 short sipe, 51 lug groove, 53 side sipe, 55 recessed window.

1. A heavy loading tire comprising a tread having a center land and shoulder lands, wherein
in the heavy loading tire in a state prior to use,
the tread includes a first circumferential groove extending in a tire circumferential direction between the center land and each of the shoulder lands, and the center land includes, in a substantially center of the center land in the tire width direction, a second circumferential groove extending in the tire circumferential direction,
the center land is segmented into center blocks by the second circumferential groove and first widthwise grooves arranged in the tire circumferential direction,
the shoulder lands are each segmented into shoulder blocks by second widthwise grooves arranged in the tire circumferential direction,
the first widthwise grooves and the second widthwise grooves have a depth that is 10% to 30% of a depth of the first circumferential groove,
the first widthwise grooves each include, on a groove bottom, a first groove bottom sipe, and the second widthwise grooves each include, on a groove bottom, a second groove bottom sipe,
the center blocks include a curved sipe and a short sipe, the curved sipe extending in the tire circumferential direction and having open ends opened to the respective first widthwise grooves, the curved sipe having two bent portions, the short sipe extending in the tire circumferential direction, the short sipe having an open end opened to the first widthwise grooves and a second end closed within the center block, and
as the tread wears, the first widthwise grooves and the second widthwise grooves disappear, and patterns of the center land and the shoulder lands change from a block pattern to a rib pattern.

2. The heavy loading tire according to claim 1, wherein
in a state of the heavy loading tire prior to use, the second circumferential groove has a width that is smaller than a width of the first circumferential grooves, and
the width of the first circumferential grooves decreases due to wear of the tread.

3. The heavy loading tire according to claim 1, wherein
the curved sipe maintains a shape of the curved sipe prior to use of the heavy loading tire when the first widthwise grooves and the second widthwise grooves disappear, and, with further wear of the tread, the curved sipe is segmented into three parts with the bending portions having disappeared.

4. The heavy loading tire according to claim 1, wherein
the first groove bottom sipes and the second groove bottom sipes maintain a shape of the first groove bottom sipes and the second groove bottom sipes prior to use of the heavy loading tire when the first widthwise grooves and the second widthwise grooves disappear, and, with further wear of the tread, the first groove bottom sipes and the second groove bottom sipes are each segmented into two parts with a center portion having disappeared.

5. The heavy loading tire according to claim 1, wherein
the first groove bottom sipes remain after the second groove bottom sipes disappear due to further wear of the tread.

6. The heavy loading tire according to claim 1, wherein
the open end of the curved sipe and the open end of the short sipe are located within a range of 15% to 20% of a width of the center block with respect to a center of the center block in the tire width direction.

7. The heavy loading tire according to claim 1, wherein
the curved sipe, in a region of the open ends and the bending portions, has a depth that is 5% to 30% of a depth of the first circumferential grooves, and, in a region other than the open ends and the bending portions, has a depth that is 50% to 70% of the depth of the first circumferential grooves.

8. The heavy loading tire according to claim 1, wherein
the first groove bottom sipes, in a center portion, have a depth that is 20% to 40% of a depth of the first circumferential grooves, and, in a region adjacent to the center portion, have a depth that is 80% to 100% of the depth of the first circumferential grooves.

9. The heavy loading tire according to claim 1, wherein
the first circumferential grooves have a width that is 2.5% to 7% of a width between contact ends of the tread, and the second circumferential groove has a width that is 2% to 5% of the width between the contact ends of the tread, and
a length between each of the first circumferential grooves and the second circumferential groove is 20% to 28% of the width between the contact ends of the tread.

10. The heavy loading tire according to claim 1, wherein
the second widthwise grooves communicate with lug grooves disposed on sidewalls, respectively, and, the lug grooves have a greater depth in the tire radial direction than a depth of the first circumferential grooves.

11. The heavy loading tire according to claim 10, wherein
a side sipe is disposed between the lug grooves, and
in the tire radial direction, the side sipe has a first end that is in contact with a contact end or reaches the tread across the contact end and a second end that reaches a location that is deeper than the first circumferential grooves.

12. The heavy loading tire according to claim 1, wherein
the heavy loading tire comprises a sidewall including a side protector protruding further outward of the tire than a profile face, the side protector having a flat top face.
